(19) United States
(12) Patent Application Publication
(10) Pub. No.: US 2018/0079100 A1
(43) Pub. Date: Mar. 22, 2018

(54) ELECTRIC SLICER WITH COMBINED GUIDE AND SUPPORT ELEMENT

(71) Applicant: Bizerba SE & Co. KG, Balingen (DE)

(72) Inventor: Timo Capone, Balingen (DE)

(21) Appl. No.: 15/705,268

(22) Filed: Sep. 15, 2017

(30) Foreign Application Priority Data
Sep. 16, 2016 (EP) 16 189 141.1

(51) Int. Cl. B26D 7/06; B26D 1/15

(52) U.S. Cl. CPC B26D 7/0616; B26D 2210/02; B26D 1/15

(57) ABSTRACT

In an embodiment, the present invention provides an electrically operated slicer for cutting slices, particularly of strand-like cutting material, preferably foodstuffs, including: a cutter that includes a circular blade driven by a blade motor, rotating about an axis of rotation in a slicing plane and mounted in a motor housing, having a stop plate for adjusting a slicing thickness which can be displaced in a direction of the axis of rotation and which is arranged parallel to the slicing plane; and a carriage carrying a support plate via a carriage foot, wherein the carriage foot can be displaced along one side of the motor housing running parallel to the slicing plane, the support plate including a support surface receiving the cutting material arranged perpendicular to the slicing plane on a horizontal plane, the carriage being guided so as to move via a carriage guide having at least two supporting elements.

### CROSS-REFERENCE TO PRIOR APPLICATION

Priority is claimed to European Patent Application No. 16 189 141.1, filed on Sep. 16, 2016, the entire disclosure of which is hereby incorporated by reference herein.

### FIELD

The invention relates to an electrically operated slicer for cutting slices, particularly of strand-like cutting material, preferably foodstuffs, having a cutter that comprises a circular blade driven by a blade motor, rotating about an axis of rotation in a slicing plane and mounted in a motor housing, having a stop plate to adjust the slicing thickness which can be displaced in the direction of the axis of rotation and which is arranged parallel to the slicing plane, having a carriage carrying a support plate via a carriage foot, wherein the carriage foot can be moved along one side of the motor housing running parallel to the slicing plane, the support plate comprising a support surface arranged perpendicular to the slicing plane on a horizontal plane to receive the cutting material, and the carriage being guided such that it can move via a carriage guide having at least two supporting elements and such that it can be displaced in a linear manner in a y direction perpendicular to the axis of rotation on a longitudinal support element connected to the motor housing and carrying the carriage parallel to the plane of the support plate and parallel to the slicing plane.

### BACKGROUND

A slicer of this type is known in the art from EP 2 635 413 B1, for example.

The cutting material, especially in automatically operated slicers for strand-like foodstuffs, such as sausages, ham, salmon, cheese, etc., is moved towards the cutter, usually in the x direction perpendicular to the slicing plane, in which one or more rotating circular blades usually rotate to cut slices of the conveyed cutting material. The cutter is driven by an electric motor which is completely enclosed by the motor housing to protect it from spray and dirt and to provide mechanical protection from external intervention.

In order to cut the required slice from the cutting material using the rotating blade, the cutting material is displaced on the support plate in the horizontal position with the carriage in the y direction parallel to the slicing plane and is moved towards the rotating blade until the rotating blade has cut through the cutting material completely and detached the slice from the cutting material.

The support plate is usually connected rigidly to the carriage guide via the carriage foot. The carriage or carriage guide is in turn arranged on the support element such that it can be displaced in a linear manner in the y direction. The carriage is supported or carried by the support element in this process.

As the carriage foot is arranged along one side of the motor housing running parallel to the slicing plane E, the carriage must be protected from tilting sideways.

A torque support is usually provided for this purpose.

Thus, in the slicer according to the above-mentioned publication, a torque support is designed in the form of two supporting elements set apart from the support element, said supporting elements being supported by the partition walls of the motor housing. The support element, supporting elements and partition walls thus form a lever system by means of which the tilting torque of the carriage can be absorbed.

Slicers having torque supports are also known in the prior art where the torque support is designed in the form of an additional guide rail which is also set apart from the support element, wherein the supporting elements of the carriage guide are supported on this additional guide rail.

The disadvantage of such an arrangement is that it makes it considerably more difficult to manufacture and assemble such a slicer. Devices to assemble the torque support, for example the above-mentioned guide rail, must be incorporated in the slicer. Extensive adjustment operations are therefore usually required to ensure that the carriage moves exactly parallel to the slicing plane both along the support element and along the guide rail or partition walls. In particular, a plurality of parts of the slicer need to be adjusted at exactly the same time for this purpose.

Furthermore, the slicer in the above-mentioned publication has provision for the support element to be designed as a rod which is grasped by the carriage guide and wherein the carriage guide can be displaced by sliding along the support element.

To improve the ability of the carriage guide to slide on the rod-shaped support element, the contact region between the carriage guide and the support element is usually lubricated with a lubricant. The carriage guide usually comprises a bushing for this purpose at its front and rear ends, which runs on the support element. The bushings are sealed from the support element by means of felt retained by a metal ring. The lubricant itself “drips” between the bushings onto the support element. However, it is inevitable that some lubricant will be lost. A reservoir for lubricant therefore needs to be provided and this must be topped up regularly. The support element also picks up lubricant residues over time due to the lost lubricant. This may lead to increased hygiene problems, especially in applications in the food industry.

### SUMMARY

In an embodiment, the present invention provides an electrically operated slicer for cutting slices, particularly of strand-like cutting material, preferably foodstuffs, comprising: a cutter that comprises a circular blade driven by a blade motor, rotating about an axis of rotation in a slicing plane and mounted in a motor housing, having a stop plate configured to adjust a slicing thickness which can be displaced in a direction of the axis of rotation and which is arranged parallel to the slicing plane; and a carriage carrying a support plate via a carriage foot, wherein the carriage foot is configured to be displaced along one side of the motor housing running parallel to the slicing plane, the support plate comprising a support surface configured to receive the cutting material arranged perpendicular to the slicing plane on a horizontal plane, and the carriage being configured to be guided so as to move via a carriage guide having at least two supporting elements and so as to be displaced in a linear manner in a y direction perpendicular to the axis of rotation on a longitudinal support element connected to the motor housing and carrying the carriage parallel to the plane of the support plate and parallel to the slicing plane, wherein the longitudinal support element comprises a combined guide and support element and forms a linear guide together with the supporting elements, wherein the guide and support element comprise a longitudinal rail and the supporting elements comprise roller elements lying on two opposite longitudinal sides of the guide and support element such that they can roll, and wherein the supporting elements lie on the guide and support element transversely with respect to the longitudinal axis of the guide and support element such that they cannot tilt.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1a is a perspective view of a first embodiment of a slicer according to the invention looking obliquely from below;

FIG. 1b is a schematic cross-sectional view in the horizontal direction of the slicer according to FIG. 1a;

FIG. 1c is a detailed view of the guide and support element with the carriage guide for the embodiment of the slicer shown in FIG. 1a arranged on top of said element;

FIG. 2a is a perspective view of an alternative embodiment of the slicer according to the invention looking obliquely from below;

FIG. 2b is a cross-sectional view of the slicer according to FIG. 2a;

FIG. 2c is a detailed view of the guide and support element with the carriage guide for the slicer shown in FIG. 2a arranged on top of said element;

FIG. 3a is a schematic cross-sectional view of a tongue and groove system formed from a guide and support element and supporting elements;

FIG. 3b is a detailed view of the cross section of the guide and support element according to FIG. 3a;

FIG. 3c is a schematic cross-sectional view of a tongue and groove system according to an alternative embodiment of the invention formed from a guide and support element and supporting elements.

### DETAILED DESCRIPTION

According to the invention, this object is achieved in a surprisingly simple and effective manner by designing the longitudinal support element as a combined guide and support element such that it forms a linear guide together with the supporting elements, wherein the guide and support element is designed as a longitudinal rail and the supporting elements are designed as roller elements lying on two opposite longitudinal sides of the guide and support element such that they can roll, and wherein the supporting elements lie on the guide and support element transversely with respect to the longitudinal axis of said guide and support element such that they cannot tilt.

The support element is thus not only used for support purposes, but also to guide the carriage.

In particular, the torque support is formed directly by the guide and support element and the supporting elements and thus forms an integral part of the guide and support element. A separate torque support is no longer necessary with the present invention.

Previously, the guide rail and support element had to be exactly aligned to the motor blade by means of eccentric cams in the production process, for example, causing the production process in the prior art to be very complex. Now, however, it is merely necessary to align the guide and support element to the motor blade or the slicing plane. There is no need to adjust the torque support separately.

As the supporting elements are designed as roller elements and lie on the guide and support element such that they can roll, no additional lubricant is required. A lubricant reservoir is thus no longer necessary. Lubricant residues on the support element can be avoided. As a result, this leads to improved hygiene compared to the prior art, which is particularly important, specifically in the food processing field.

As the guide and support element according to the invention is designed as a longitudinal rail and the supporting elements are designed as roller elements lying on said rail, the carriage guide may be configured such that it only encloses the guide and support element in part. It can then advantageously be provided that the guide and support element is be fixed rigidly to the motor housing at least at certain points along its longitudinal axis. As a result, the carriage can be protected more effectively from tilting transversely with respect to the longitudinal axis of the guide and support element.

It can also advantageously be provided that the guide and support element has a polygonal cross section, in particular a rectangular, hexagonal or octagonal cross section. If the guide and support element designed as a rail has such a polygonal cross section, the supporting elements designed as roller elements may lie on the guide and support element with a relatively large contact surface. In particular, this allows the supporting elements to transfer torques to the guide and support element more effectively. As a result, this can also help avoid undesirable tilting of the carriage or make this more difficult.

In a particularly advantageous embodiment of the invention, it can be provided that the supporting elements are arranged at a predefined fixed distance from each other. As a result, the supporting elements may contact or grasp the guide and support element on opposite sides of said element in the manner of a pair of tongs. The supporting elements arranged on two opposite longitudinal sides of the guide and support element can thus mutually prevent the supporting elements slipping or releasing from the guide and support element, for example.

It is particularly advantageous if the positions of the supporting elements, including their respective distances when installed in the motor housing, can be adjusted such that the guide of the carriage is aligned exactly in relation to the slicing plane of the circular blade and in relation to the stop plate. For example, the supporting elements may be arranged on the carriage guide by means of eccentric cams. This makes it particularly easy to adjust or align the carriage drive along the guide and support element, especially with a view to obtaining clean slices of the cutting material.

A particularly preferred class of embodiments of the invention is one in which the support elements lie on the guide and support element transversely with respect to the longitudinal axis of said guide and support element by means of a tongue and groove system such that they do not tilt. For example, the guide and support element may be designed in the form of a tongue on each of its two opposite longitudinal sides. The tongue may, for example, be designed as a longitudinal side of the guide and support element with a triangular cross section. The supporting elements designed as roller elements may then be in the form of grooves. In particular, the roller elements may preferably have an indentation in the middle of their running surface, which is preferably complementary to the tongues. In other words, the roller elements may be designed as grooved wheels. The tongue and groove system leads to a particularly effective torque support for the roller elements transversely with respect to the longitudinal axis of the guide and support element.

To facilitate such a complementary design of the tongues and grooves respectively, the tongues may be formed with a tapered cross section. The respective impact angle thus arising at one end of the tongues may be less than 90°, preferably 60° to 85°, particularly preferably 80°. This thus ensures that the tongue can penetrate sufficiently deeply into the respective groove.

The supporting elements can also be designed as double rollers, preferably manufactured in one piece. Thus, appropriate grooves can be provided in a simple manner in the region of the contact surfaces of the two individual rollers each forming a double roller.

In a particularly preferred embodiment of the invention, the axes of rotation of the supporting elements in the form of roller elements arranged on opposite sides of the guide and support element are arranged parallel to one another and transversely with respect to the longitudinal axis of the guide and support element. This thus makes it possible to align the running surfaces of the roller elements such that they are parallel and/or complementary to each other. Thus, the roller elements can support each other more effectively on the guide and support element.

In an alternative class of embodiments of the invention, it can be provided that the supporting elements arranged on opposite sides of the guide and support element are designed as a pair of rollers, wherein the rollers in each pair of rollers are arranged such that one roller of each pair of rollers lies on the guide and support element transversely with respect to the longitudinal direction of said guide and support element such that it cannot tilt due to the respective other roller or lies on a guide piece rigidly connected to said guide and support element. The guide piece may in particular form part of the guide and support element. Thus, pairs of rollers may in particular be used as supporting elements, the axes of rotation of the individual rollers of the pairs of rollers preferably being aligned in different directions. The individual rollers can thus be fitted to the guide and support element or to the guide piece from different directions. As a result, the torque support functionality, i.e. preventing the carriage from tilting, can be further substantially improved.

In practice, it is advantageous if the axes of rotation of the rollers in a pair of rollers are arranged at an angle, preferably perpendicular to one another.

Other features and advantages of the invention are explained in the following detailed description of embodiments of the invention with the aid of the drawings which show details of the invention, and in the claims. The individual features may be used individually or combined in any combination in variations of the invention.

Embodiments of the invention are shown in the schematic drawings and explained in more detail in the following description.

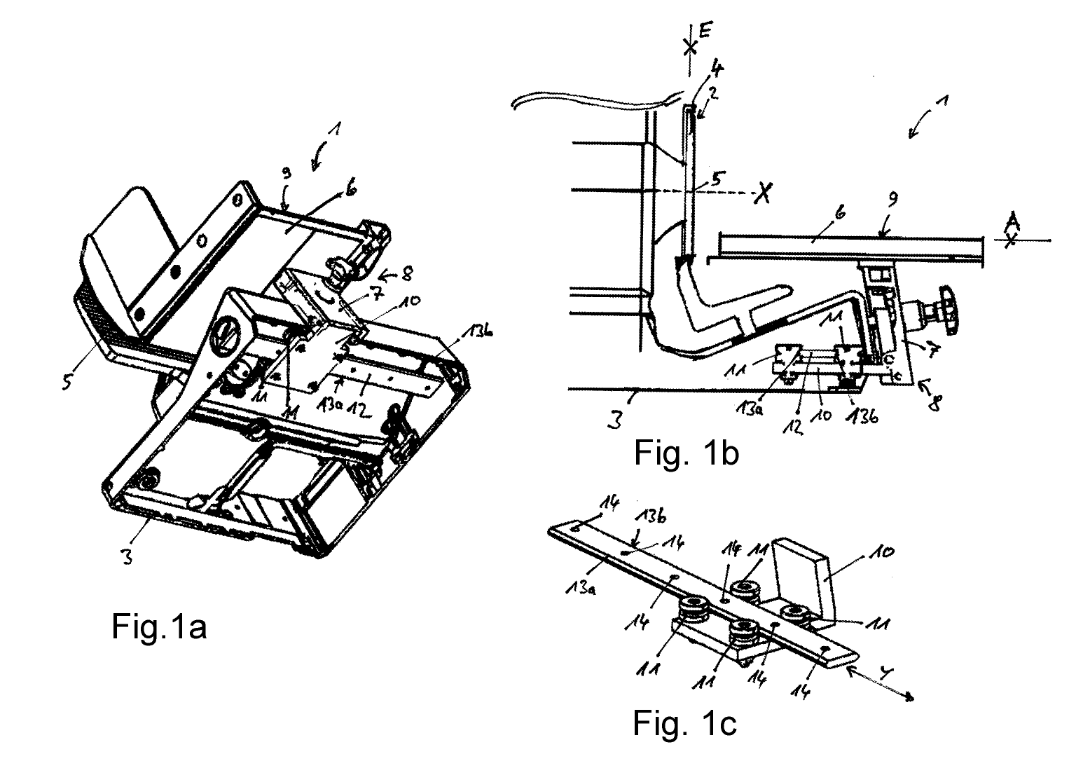

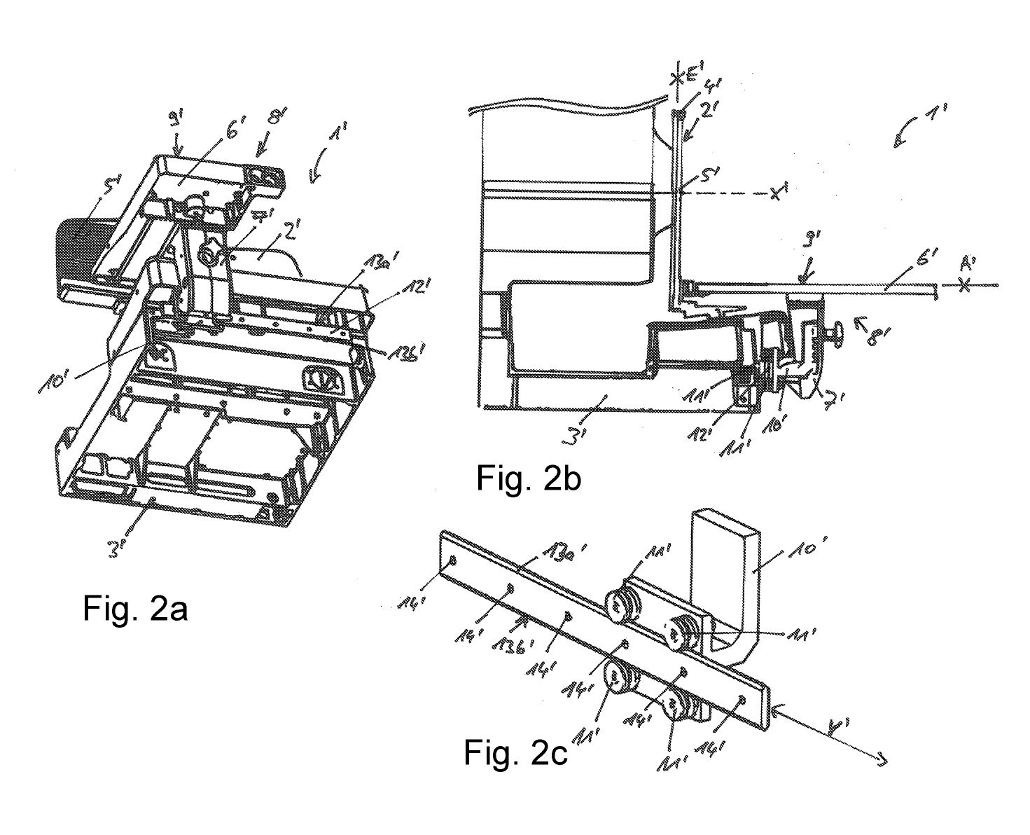

For ease of understanding, elements having the same function are provided with the same reference numerals in the drawings. Reference numerals for the embodiment of the invention in FIG. 1a to FIG. 1c are shown without an apostrophe, whereas reference numerals for the slicer according to the embodiment in FIG. 2a to FIG. 2c are shown with apostrophes for ease of understanding.

FIG. 1a to FIG. 1c and FIG. 2a to FIG. 2c respectively show electrically operated slicers 1, 1′ for cutting slices, particularly of strand-like cutting material, preferably foodstuffs. The slicers 1, 1′ comprise cutters 2, 2′, which each comprise a circular blade 4, 4′ mounted in a motor housing 3, 3′, rotating about an axis of rotation X, X′ in a slicing plane E, E′ and driven by a blade motor which is not shown in greater detail for simplification purposes.

Stop plates 5, 5′ are arranged parallel to the slicing planes E, E′ and can be displaced in the direction of the axes of rotation X, X′ to adjust the slicing thickness. Support plates 6, 6′ for the carriage 8, 8′ are also shown, said support plates being carried by a carriage foot 7, 7′ of the respective carriage 8, 8′. The respective carriage foot 7, 7′ can be displaced along one side of the motor housing 3 or 3′ running parallel to the respective slicing plane E, E′.

The support plates 6, 6′ also each comprise a support surface 9, 9′ to receive the cutting material, which support surface is arranged on a horizontal plane A or A′ perpendicular to the respective slicing plane E, E′.

The carriage 8, 8′ is in each case guided by means of a carriage guide 10, 10′, which comprises at least two supporting elements 11, 11′, such that it can move.

It can also be displaced in a linear manner in a y, y′ direction perpendicular to the axis of rotation X, X′ on a longitudinal support element connected to the motor housing 3, 3′, and carrying the carriage 8, 8′ parallel to the plane A, A′ of the support plate 6, 6′ and parallel to the slicing plane E, E′.

It is particularly evident that the respective support element is designed as a combined guide and support element 12, 12′. In particular, the guide and support element 12, 12′ is designed as a longitudinal rail. It forms a linear guide in each case together with the carriage guides 10, 10′ and the supporting elements 11, 11′ arranged on said guides. To this end, the supporting elements 11, 11′ are designed as roller elements lying on two opposite longitudinal sides 13a, 13b or 13a′, 13b′ respectively of the guide and support element 12, 12′ such that they can roll.

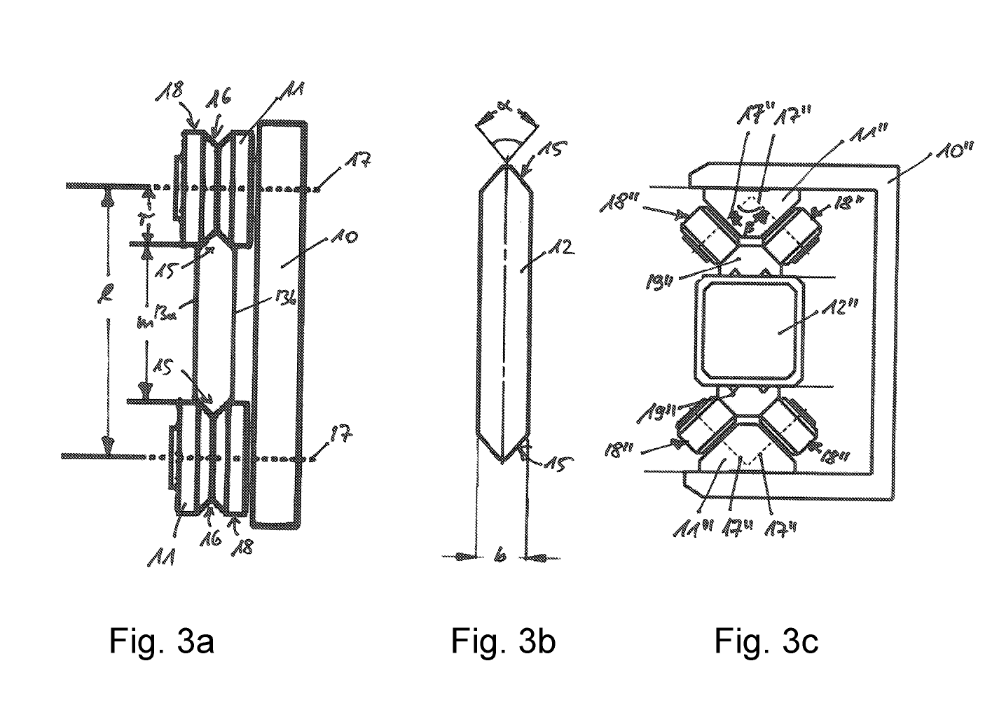

The linear guide means that the carriages 8, 8′ cannot only be carried, but are also protected from tilting. In this respect, FIG. 1a to 1c or 2a to FIG. 2c respectively also show that the supporting elements 11, 11′ lie on the guide and support element transversely in relation to the respective longitudinal axis of said guide and support element 12 or 12′ such that they cannot tilt. Further details of this are described below in connection with FIG. 3a to FIG. 3c.

The embodiments shown in FIG. 1a to 1c and FIG. 2a to FIG. 2c differ in particular in relation to the installation position of the respective guide and support element 12, 12′ and the associated configuration of the carriage guides 10, 10′.

In particular, it is evident that in the embodiment shown in FIG. 1a to FIG. 1c (slicer 1) the guide and support element 12 is installed in the motor housing 3 in a horizontal position. Accordingly, the carriage guide 10 extends underneath the guide and support element 12 along with its supporting elements 11.

In the embodiment shown in FIG. 2a to FIG. 2c (slicer 1′), on the other hand, the guide and support element 12′ is installed in the motor housing 3′ in a vertical position. Accordingly, in this embodiment, the carriage guide 10′ with its supporting elements 11′ is designed such that it grasps the guide and support element 12′ vertically, i.e. parallel to the slicing plane E′.

In the embodiments shown in this case, the guide and support elements 12, 12′ are fixed to the respective motor housing 3, 3′ at their top ends. In other embodiments of the invention, it is provided that the guide and support elements 12 or 12′ may additionally or alternatively be fixed at least at specific points along the wide sides of the guide and support elements 12, 12′ at attachment points 14 or 14′ on the respective motor housing 3, 3′ such as to ensure particularly good stability, especially with regard to tilting of the carriage 8, 8′.

FIGS. 3a to 3c are used to explain in more detail how a torque support is incorporated in a guide and support element according to the invention. To this end, FIG. 3a and FIG. 3b show by way of example detailed views of FIG. 1c or the slicer 1 respectively. Persons skilled in the art will be aware that the alternative embodiments of the carriage guide, supporting elements and the guide and support element according to FIG. 3c can be provided instead of the corresponding embodiments according to FIG. 1c or FIG. 2c respectively to construct a slicer according to the invention which is constructed in a comparable manner to the slicers 1, 1′.

To this end, FIG. 3a shows a cross section through the guide and support element 12 and the carriage guide 10 with its supporting elements 11. It is evident that the supporting elements 11 designed as roller elements are mounted in the carriage guide 10 with their wheel axles 17 such that they can rotate. In particular, the wheel axles 17 of the supporting elements 11 lying on opposite longitudinal sides 13a, 13b of the guide and support element 12 are aligned parallel to one another. In this case, the distance 1 between the wheel axles 17 is adjusted such that it corresponds to the external height m of the guide and support element 12 less twice the wheel radius r of a supporting element 11. The external height m corresponds to the width of the longitudinal sides 13a, 13b in this case.

The position of the wheel axles 17 can, for example, be adjusted by eccentric screws. By adjusting it is possible to ensure that the supporting elements 11 lie on the guide and support element 12 without interruption.

It is also evident that the guide and support element 12 comprises tongues 15 from a tongue and groove system on two outer regions. Each tongue 15 is in this case designed as a corner of the guide and support element 12 with a tapered cross section. In this case, each tongue 15 engages in a groove 16 of the respective supporting element 11, said groove being complementary to the tongue 15. In this embodiment, the supporting element 11 is indented for this purpose in a middle region along its running surface 18. This ensures that the supporting elements 11 can also be supported in relation to the guide and support element 12 transversely with respect to the longitudinal direction of said guide and support element. Furthermore, as the distance 1 between the supporting elements 11 is fixed, any torques can be transferred from the carriage guide 10 to the guide and support element 12. The arrangement according to the invention thus performs the function of a torque support.

FIG. 3b shows another detailed view with the guide and support element 12. FIG. 3b also shows an impact angle α, i.e. the angle at which the side surfaces of the guide and support element 12, which form the respective tongue 15, are joined. In this embodiment, the impact angle α is 80°.

The width b of the guide and support element 12 is also selected such that the tongues 15 engage completely in the grooves 16, but that it is still possible to ensure that the supporting elements 11 roll with limited rolling resistance along the guide and support element 12.

FIG. 3c shows an alternative embodiment of a carriage guide 10″ having supporting elements 11″ which are each supported by means of a guide piece 19″ on opposite sides of a guide and support element 12″ such that they can roll. The supporting elements 11″ are each designed as pairs of rollers in this case. It is evident that the rollers of the supporting elements or pairs of rollers 11″ with their wheel axles 17″ are arranged at a predefined axle angle β with respect to one another. In this case, the axle angle β is 90°. In other words, the rollers of the pairs of rollers or supporting elements 11″ are arranged perpendicular to one another. The guide pieces 19″ have a polygonal cross section which is formed such that the supporting elements 11″ are in each case supported across a large surface on the respective guide piece 19″ with the running surfaces 18″ of their individual rollers.

A torque or tilting moment applied to the carriage guide 10″ due to the carriage tilting can thus be transferred in full to the respective guide pieces 19″ by means of the wheel axles 17″ and the running surfaces 18″. The rollers of each pair of rollers are thus arranged such that one roller of each pair of rollers lies on the guide and support element 12″ or on the respective guide piece 19″ due to the respective other roller transversely with respect to the longitudinal direction of the guide and support element 12″ such that it cannot tilt.

The guide pieces 19″ are in each case rigidly connected to the guide and support element 12″ such as to in turn produce an overall linear guide in which a torque support is incorporated.

A separate torque support is thus no longer necessary.

It is therefore particularly simple to manufacture and assemble the slicer and cutter according to the invention and, in particular, any necessary adjustment operations are made easier as it is merely necessary to align or adjust a linear guide.

As the carriage guides 10, 10′, 10″ roll on the respective guide and support elements 11, 11′, 11″, instead of sliding along said elements, there is also no need for additional lubrication by means of a lubricant or for a reservoir for this purpose.

Use of a slicer according to the invention also fulfills even very exacting hygiene requirements, especially as there is no longer any possibility of lubricant residues.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1, 1′ slicer
2, 2′ cutter
3, 3′ motor housing
4, 4′ circular blade
5, 5′ stop plate
6, 6′ support plate
7, 7′ carriage foot
8, 8′ carriage
9, 9′ support surface
10, 10′, 10″ carriage guide
11, 11′, 11″ supporting element
12, 12′, 12″ guide and support element
13a, 13b, 13a′, 13b′ longitudinal sides
14, 14′ attachment points
15 tongue
16 groove
17, 17″ wheel axle
18, 18″ wheel profile
19″ guide piece
X, X′ axis of rotation
E, E′ slicing plane
A, A′ horizontal plane
y, y′ direction
l distance
m external distance
r wheel radius
α impact angle
b width
β axle angle

What is claimed is:

1. An electrically operated slicer for cutting slices, particularly of strand-like cutting material, preferably foodstuffs, comprising:
a cutter that comprises a circular blade driven by a blade motor, rotating about an axis of rotation in a slicing plane and mounted in a motor housing, having a stop plate configured to adjust a slicing thickness which can be displaced in a direction of the axis of rotation and which is arranged parallel to the slicing plane; and
a carriage carrying a support plate via a carriage foot, wherein the carriage foot is configured to be displaced along one side of the motor housing running parallel to the slicing plane, the support plate comprising a support surface configured to receive the cutting material arranged perpendicular to the slicing plane on a horizontal plane, and the carriage being configured to be guided so as to move via a carriage guide having at least two supporting elements and so as to be displaced in a linear manner in a y direction perpendicular to the axis of rotation on a longitudinal support element connected to the motor housing and carrying the carriage parallel to the plane of the support plate and parallel to the slicing plane,
wherein the longitudinal support element comprises a combined guide and support element and forms a linear guide together with the supporting elements,
wherein the guide and support element comprise a longitudinal rail and the supporting elements comprise roller elements lying on two opposite longitudinal sides of the guide and support element such that they can roll, and
wherein the supporting elements lie on the guide and support element transversely with respect to the longitudinal axis of the guide and support element such that they cannot tilt.

2. The slicer according to claim 1, wherein the guide and support element is fixed rigidly to the motor housing at least at certain points along its longitudinal axis.

3. The slicer according to claim 1, wherein the guide and support element has a polygonal cross section.

4. The slicer according to claim 1, wherein the supporting elements are arranged at a predefined, fixed distance from one another.

5. The slicer according to claim 4, wherein positions of the supporting elements including their respective distances are configured to be adjusted when installing in the motor housing such that the guide for the carriage is aligned precisely in relation to the slicing plane of the circular blade and in relation to the stop plate.

6. The slicer according to claim 1, wherein the supporting elements lie on the guide and support element transversely with respect to the longitudinal axis of the guide and support element via a tongue and groove system such that they cannot tilt.

7. The slicer according to claim 6, wherein an impact angle of the tongue is less than 90°.

8. The slicer according to claim 6, wherein the supporting elements comprise as double rollers.

9. The slicer according to claim 1, wherein the axes of rotation of the supporting elements arranged on opposite sides of the guide and support element and comprise roller elements are arranged such that they run parallel to one another and transversely with respect to the longitudinal axis of the guide and support element.

10. The slicer according to claim 1, wherein the supporting elements arranged on opposite sides of the guide and support element comprise pairs of rollers, wherein the rollers in each pair of rollers are arranged such that one roller from each pair of rollers lies on the guide and support element transversely with respect to the longitudinal direction of the guide and support element such that it cannot tilt due to the respective other roller or lies on a guide piece rigidly connected to the guide and support element.

11. The slicer according to claim 10, wherein the axes of rotation of the rollers in a pair of rollers are arranged at an angle, preferably perpendicular to one another.

12. The slicer according to claim 1, wherein the polygonal cross section comprises a rectangular, hexagonal, or octagonal cross section.

13. The slicer according to claim 7, wherein the impact angle is between 60° to 85°.

14. The slicer according to claim 13, wherein the impact angle is 80°.

15. The slicer according to claim 8, wherein the double rollers are manufactured in one piece.
